(19) United States
(12) Patent Application Publication
(10) Pub. No.: US 2010/0023417 A1
(43) Pub. Date: Jan. 28, 2010

(54) METHOD AND ARRANGEMENT FOR PROVIDING SECURITY FOR CONTENT PURCHASES

(75) Inventors: Steinar Dahlin, Jarfalla (SE); Anders Ryde, Saltsjobaden (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 12/306,828

(22) PCT Filed: Jun. 28, 2006
(86) PCT No.: PCT/SE2006/000791

§ 371 Date: Sep. 2, 2009

(51) Int. Cl. G06Q 30/00; G06F 15/16; G06F 21/00

(52) U.S. Cl. 705/26; 709/206; 726/3

(57) ABSTRACT

A method and arrangement for providing security when an IMS client purchases content from a content or service provider, the IMS client having a unique IMS identity registered with a first IMS operator. A second IMS operator assigns a unique IMS identity to the content or service provider which is authenticated based on the assigned IMS identity. The validity of the IMS client is then verified towards the content or service provider, based on a mutual interconnect agreement between the first and second IMS operators, in response to a purchase request from the IMS client. The content or service provider can then also be validated towards the IMS client.

### TECHNICAL FIELD

The present invention relates generally to a method and arrangement for providing security when an IMS client purchases content from a content or service provider. In particular, the invention can be used to validate the IMS client towards the content or service provider, and vice versa, and to enable simplified and reliable charging procedures.

### BACKGROUND

With the emergence of 3G mobile telephony, new packet-based communication technologies have been developed for communicating multimedia content. For example, technologies such as GPRS (General Packet Radio Service) and WCDMA (Wideband Code Division Multiple Access) support wireless multimedia telephony services involving packet-switched communication of data representing images, text, documents, animations, audio files, video files, etc., in addition to traditional circuit-switched voice calls.

Recently, a network architecture called “IP Multimedia Subsystem” (IMS) has been developed by the 3^{rd} Generation Partnership Project (3GPP) as an open standard, to provide multimedia services for mobile and fixed clients in the packet data domain. IMS is generally a platform for multimedia services based on IP (Internet Protocol) transport, more or less independent of the access technology used. Basically, any types of access networks with packet-switching capabilities can be connected to an IMS network, including networks based on GPRS/UMTS, WLAN, fixed broadband, cable television, etc. IMS clients can generally communicate multimedia with other IMS clients as well as with various server sites, often generally referred to as content providers.

A specification for session setup has been defined called “SIP” (Session Initiation Protocol), which is an application-layer signalling protocol for controlling sessions over a packet-switched logic. SIP is independent of the underlying data transport technologies, and has been selected for use by IMS networks to support multimedia services.

FIG. 1 illustrates schematically a basic IMS network structure 100 that provides multimedia services to, e.g., a client A using a mobile terminal connected to a radio access network 102. It should be noted that the figure is greatly simplified and shows only a selection of network nodes helpful to understand the context of the present invention. Client A may communicate in a packet-switched data session S with another client B that may use a mobile or fixed terminal or a PC (Personal Computer).

The IMS network 100 is connected to the radio access network 102 and controls the session S as well as any other multimedia services for client A, including sessions with server sites. A corresponding IMS network (not shown) may handle the session S for client B. Clients A and B may of course be connected to the same access network and/or belong to the same IMS network. In this figure, a plurality of further IMS networks 104 are schematically shown.

The illustrated session S is managed by a node called S-CSCF (Serving Call Session Control Function) 106 assigned to client A in the IMS network 100, and the used multimedia service is enabled and executed by an application server among a plurality of application servers 108. Further, a main database element HSS (Home Subscriber Server) 110 stores subscriber and authentication data as well as service information, among other things, that the application servers 108 and S-CSCF node 106 can retrieve for executing services for clients.

IMS network 100 also contains the nodes I-CSCF (Interrogating Call Session Control Function) 112 receiving messages from other IMS networks 104, and P-CSCF (Proxy Call Session Control Function) 114 acting as an entry point or “proxy” for clients connected to access network 102. Suitable interfaces are provided for making any necessary translations and conversions between the IMS network 100 and connected access networks on one side, and the other IMS networks 104 on the other side.

E-commerce, e.g. involving purchasing over the Internet, has rapidly become popular and widely practised. Customers can contact specific content providers all over the world over the Internet to buy various objects, such as media, articles, services and information, often generally referred to as “content”. Fixed personal computers and mobile terminals with Internet capabilities are typically used for accessing content providers over the Internet. For example, content in the form of different media including music, films, software and games is often purchased and transferred or downloaded over the Internet.

In order to establish some kind of trusted relationship, the buyer may register with the content provider, typically involving the establishment of a user identity and password, and receive invoices for purchases made. The customer may also provide a credit card number, account number or the like which can be charged for executed purchases. However, customers often refrain from carrying out a purchase on these terms, particularly when small sums are involved, e.g. due to the inherent insecurity of sending sensitive registration data and credit card numbers over the Internet, or simply due to the effort required. Using a user identity/password combination is supposed to provide some degree of security, but the risk of illicit interception by an unknown party cannot be completely eliminated.

To overcome these difficulties, operators of access networks often establish business relationships directly with selected content providers in order to offer content to their subscribers. Since a subscriber has some type of “billing relation” with its access operator, the operator can safely charge the subscriber for any purchased content from such content providers.

In current solutions for charging customers for accessed content by means of their regular subscription bills, a great number of separate relationships and technical interfaces are typically needed between access operators and content providers. WO 2004/086276 discloses a solution for reducing that number significantly by introducing a central transaction router as a payment mediator between plural access operators and plural content providers. FIG. 2 illustrates such a transaction router 200, sometimes referred to as IPX (Internet payment exchange), having a trusted relationship and interfaces with each of a plurality of access operators 202 (A,B,C . . . ), and also with each of a plurality of content providers 204.

Hence, in this solution, only one business agreement and one set of necessary technical interfaces is established with the transaction router 200 for each operator 202 and each content provider 204, respectively, resulting in a reduced total number of individually adapted relationships and interfaces, as indicated with arrows. Moreover, secure content purchases are supported from any content provider over any access operator, when connected to the transaction router 200.

Traditional networks for communication services were originally designed for person-to-person voice communication only, but have been used more recently also for communication with content providers, making use of specific characteristics provided by these networks. One such important characteristic is that a subscriber accessing content from a content provider can be identified and authenticated by the access network in a sufficiently secure manner, such that he/she can be safely charged for the content accessed, hence the above-mentioned “billing relation”. Since different operators of such traditional access networks typically have mutual so-called interconnect agreements, any charged amounts for accessed content and used communication resources can be collected on the same bill to the subscriber from his/her home network operator.

In IMS networks, subscribers or clients have unique identities which are used for authentication. It is required that a terminal accessing an IMS network has access to an IMS SIM (Subscriber Identity Module) or “ISIM” application, in order to provide necessary authentication and subscriber data to an operator of the IMS network. Today, only IMS enabled terminals are allowed to access an IMS network.

An ISIM application is typically installed on a Universal Integrated Circuit Card (UICC), analogous to the well-known SIM card for GSM terminals. Among other things, an ISIM stores an IMS Private Identity referred to as “IMPI” and at least one IMS Public Identity referred to as “IMPU”, which are both known to the IMS network. An IMPI is a unique identity used for authentication and is not to be disclosed to third parties, whereas an IMPU can be used as an “alias” to officially identify a client when participating in IMS services, as analogous to an e-mail address or a telephone number. The intention is that each IMPU can be associated with a specific IMS service profile. Of course, the association between an IMPI and one or more IMPU's for a client is administrated by the IMS operator.

When two subscribers or clients connected to respective access networks communicate with each other, each client is safely identified and authenticated by his/her home operator, respectively. In other words, their identities can be “guaranteed” by the home operators, which is illustrated in FIG. 3 where a client A communicates with another client B.

Client A belongs to a first home operator 300 and communicates by means of a first access medium 302, such as a mobile network, which may be a home network or a visited network. The first home operator 300 has assigned a unique identity ID_{A} to client A. Likewise, client B belongs to a second home operator 304 and communicates over a second access medium 306. A unique identity ID_{B} is assigned to client B by home operator 304. Thus, identities ID_{A} and ID_{B} are used for authentication of clients A and B, respectively.

If the two operators 300,304 have a mutual interconnect agreement, as indicated by the two-way arrow in the figure, a communication “pipe” 308 can be safely established between the clients A,B for media in either direction, based on the authentication made with each home operator 300,304 using the guaranteed identities ID_{A} and ID_{B}.

However, when accessing content sites or content providers over the Internet, it is a problem that the identity and trustworthiness of any client cannot be guaranteed towards a content provider, unless that content provider has established a trusted relationship directly with the client's home network operator, or the above-described IPX solution is used. On the other hand, it may also be a problem that the identity of any content provider cannot be guaranteed towards a client. For example, it is desirable to avoid the risk that an unnoticed third party might reroute a purchase dialogue or the like with a client, to illicitly capture his/her user identity/password combination or credit card number.

Today, it is not possible to obtain the security of identification and billing offered by traditional access networks when accessing content providers for purchasing content. In particular, it is desirable to avoid the exchange of sensitive registration and/or credit card information over the Internet when purchasing content, and to generally simplify the purchase process including billing.

### SUMMARY

The object of the present invention is to address the problems outlined above. This object and others are obtained by providing a method and arrangement according to the attached independent claims.

According to different aspects, a method and an apparatus are defined for providing security when an IMS client purchases content from a content or service provider, the IMS client having a unique IMS identity registered with a first IMS operator.

In a method according to one aspect, a unique IMS identity is assigned to the content or service provider by a second IMS operator, and the content or service provider is authenticated based on its assigned IMS identity. The validity of the IMS client can then be verified towards the content or service provider in response to a purchase request from the IMS client, where the first and second IMS operators have settled a mutual interconnect agreement.

An arrangement according to another aspect comprises means for assigning a unique IMS identity to said content or service provider by a second IMS operator. The arrangement further comprises means for authenticating the content or service provider based on the assigned IMS identity, and means for verifying the validity of the IMS client towards the content or service provider in response to a purchase request from the IMS client, where the first and second IMS operators have settled a mutual interconnect agreement.

Different embodiments of the inventive method and arrangement can also be provided. At least one alias associated with the IMS client's IMS identity may be verified towards the content or service provider. Furthermore, the validity of the content or service provider may also be verified towards the IMS client. At least one alias associated with the content or service provider's IMS identity may then also be verified towards the IMS client, each alias representing an offered product or service.

If an IMS communication session is conducted between the IMS client and the content or service provider, the session may involve a purchase dialogue and/or delivery of media from the content or service provider.

The second IMS operator may charge the first IMS operator for the client's content purchase and then provide reimbursement for the purchase to the content or service provider. The first IMS operator may then be charged based on session-related input from an application server invoked for the communication session.

A charging function of the second IMS operator may receive charging input from the content or service provider regarding the content purchase for media delivered during the session, and/or for content delivered separately. Further, the charging function of the second IMS operator may provide relevant charging information to a charging function of the first IMS operator, in order to charge the first IMS operator for the client's purchase. The charging function of the first IMS operator can also create a bill to the client for the purchase, based on the charging information from the charging function of the second IMS operator. The charging function of the second IMS operator can also be financially compensated by the charging function of the first IMS operator for the purchase.

Further preferred features of the present invention and its benefits can be understood from the detailed description below.

### BRIEF DESCRIPTION OF THE DRAWINGS

The present invention will now be described in more detail by means of preferred embodiments and with reference to the accompanying drawings, in which:

FIG. 1 is a schematic block diagram including an IMS network serving a client A, according to the prior art.

FIG. 2 is a schematic block diagram illustrating trusted relationships between access operators and content providers by means of a central transaction router, according to the prior art.

FIG. 3 illustrates a communication scenario involving communicating clients A and B, according to the prior art.

FIG. 4 illustrates a communication scenario involving an IMS client A and a content provider, according to one embodiment.

FIG. 5 is a block diagram illustrating a communication session between an IMS client A and a content provider C, according to further embodiments.

FIG. 6 is a flow chart illustrating a procedure for billing an IMS client when purchasing content from a content provider, according to another embodiment.

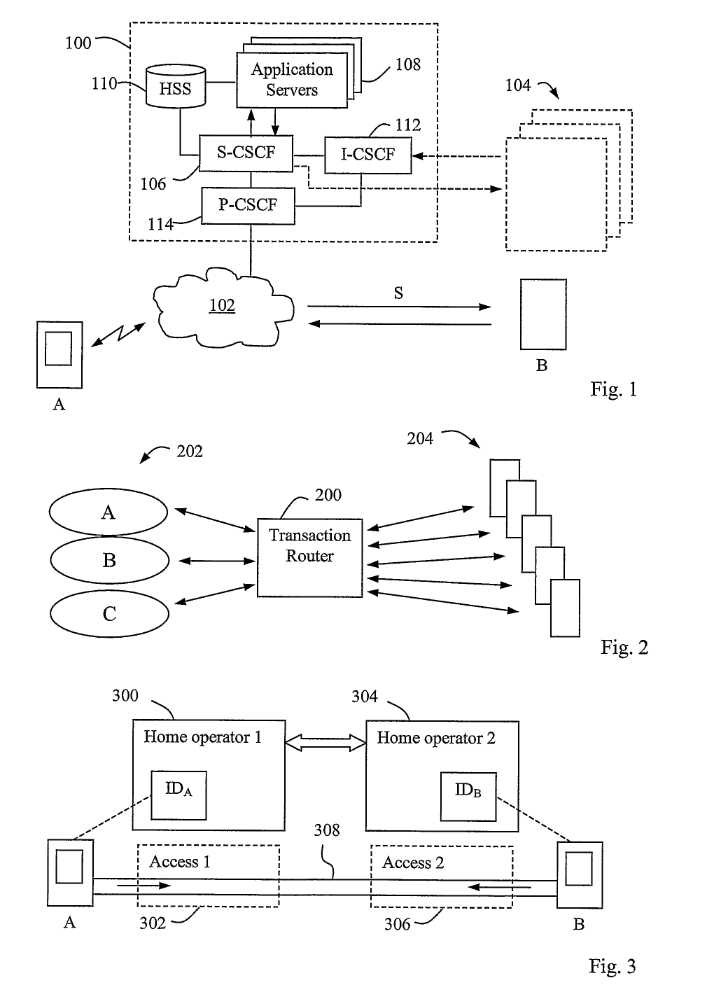

### DETAILED DESCRIPTION

Briefly described, the present invention can be used to guarantee the identity and authenticity of an IMS client towards a content provider, and vice versa, allowing for relatively safe and simplified content purchases by IMS clients. According to this solution, a content provider is attached to an IMS operator and has a unique IMS identity registered with the IMS operator, basically in the same way as IMS clients. Thereby, the inherent safety functions of IMS networks are utilised to ensure a safe relationship between a content buying IMS client and an IMS-attached content provider, if their respective IMS operators have a mutual interconnect agreement to guarantee the identities of client and provider, respectively. In addition, existing mechanisms for charging and billing in the IMS networks can be utilised for collecting payment from the buying IMS client to the selling IMS-attached content provider, for any purchased content.

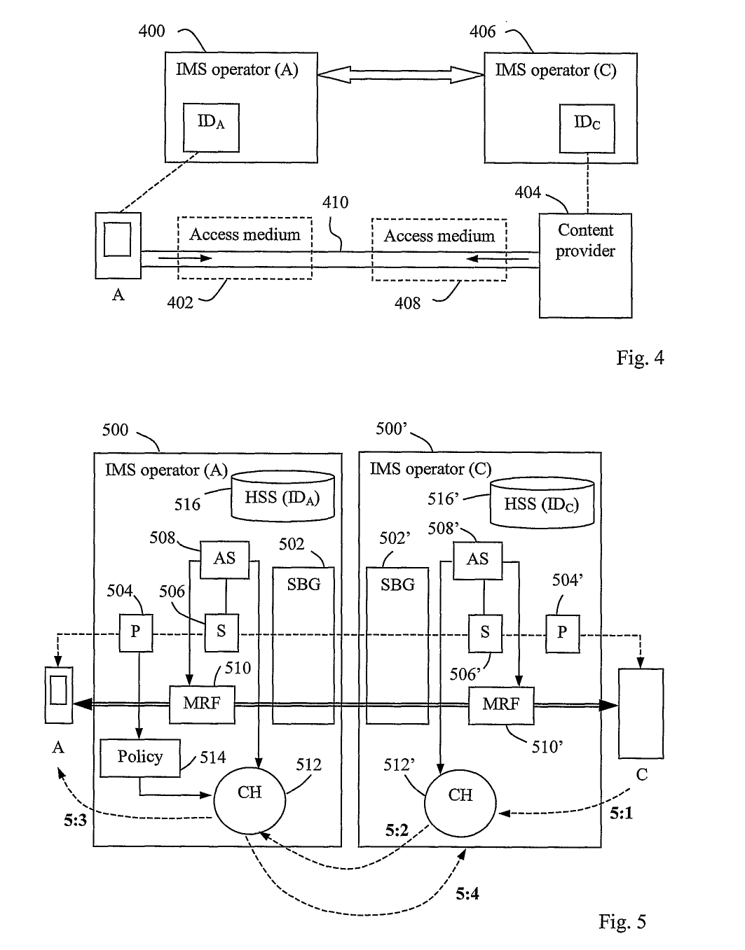

FIG. 4 illustrates a client A registered as a subscriber with an IMS operator 400 and using a mobile terminal connected to an access medium 402, in this case a mobile or cellular network, served by IMS operator 400. The terminal used may be a multi-access type terminal capable of using different types of access media such as GSM, CDMA, WCDMA, WLAN, etc. The present invention is thus not limited in this respect.

Being an IMS subscriber, client A has a unique basic identity ID_{A} assigned by IMS operator 400, i.e. in the same way as client A in FIG. 3. This identity ID_{A} is preferably the above-mentioned IMS Private Identity (IMPI) stored on an ISIM in the terminal, which is only used in a conventional manner for authenticating client A, e.g., when the terminal is powered-on and registers with the IMS operator 400. As mentioned above, the client has also one or more public identities or aliases, such as the above-mentioned IMS Public Identity (IMPU), which are associated with the identity ID_{A}. Thereby, the IMS operator 400 can guarantee each public identity or alias towards content providers, based on the identity ID_{A}. Client A has also some kind of billing relation established with his/her IMS operator 400 for communication services involving multimedia, either pre-paid or post-paid.

In accordance with the present solution, a content or service provider 404 has been registered with another IMS operator 406 as an “IMS content provider”, and IMS operator 406 has assigned a unique identity ID_{C} to content provider 404, as indicated in the figure. As shown in the figure, content provider 404 is also connected to some type of access medium 408 served by IMS operator 406. Moreover, a plurality of public identities or aliases can be assigned for different products or services offered by the content or service provider 404. The IMS addressing structure referred to as PSI (Public Service Identifier) is then used.

The identity ID_{C} is used for certifying the identity of content provider 404 to ensure a trusted relationship, basically as for any registered IMS client. Thereby, the IMS operator 406 can guarantee any associated public identities or aliases, selected by the provider for its products/services, towards clients, based on the identity ID_{C}.

However, a content provider server site is normally not powered on and off frequently like a user terminal, but is typically activated or initiated on a more long-term basis. Authentication of the provider and its products/services in the IMS network can be handled by means of any traditional business interfaces such as IP-sec tunnels or the WebService Security. However, it is also possible to utilise the authentication routines and mechanisms employed for IMS clients.

Thus, client A can make content purchases from content provider 404 by means of an IMS controlled communication session. By way of example, data such as music, films, software, etc. may be downloaded from content provider 404 to the terminal used by client A during the communication session. The purchased content may also be any physical objects or services that are delivered “outside” the used access medium, e.g. by regular post mail or otherwise. In this description, the term “content provider” generally represents any IMS-accessible server site from which such content and/or services can be purchased or otherwise obtained. In particular, the present solution can be used to great advantage when the content is delivered over the access medium, as the content delivery is controlled by the IMS operator of the buying client.

It is assumed that the IMS operators 400 and 406 have a mutual interconnect agreement, i.e. trusted relationship, as indicated by the two-way arrow, such that IMS operator 400 can guarantee the identity of client A, and IMS operator 406 can guarantee the identity of content provider 404 and any aliases of offered products/services. A communication pipe 410 can therefore be safely established between client A and content provider 404 in order to execute the purchase. The pipe 410 can be used to convey a purchase dialogue between the parties, and optionally also to convey purchased content if necessary. The pipe 410 may also be used to legally validate the purchase during the purchase dialogue, unless other separate procedures are used such as the previously known “Two-Phase Commit Protocol (2PC)”. Moreover, client A can be safely charged by IMS operator 400, relying on their existing billing relation, for any content purchased from content provider 404, as well as for any utilised communication resources (of the pipe 410) in connection with the purchase.

FIG. 5 illustrates in more detail how such a content purchase can be conducted by means of a communication session between a client A attached to an IMS operator 500 and a content or service provider C attached to another IMS operator 500′. The skilled person will appreciate that the description for FIG. 5 is greatly simplified, and numerous further nodes, functions and messages are involved when conducting the following procedure, although these are not necessary to describe here to understand the present invention.

In the present example, IMS operators 500 and 500′ have a mutual interconnect agreement, as described above. IMS operator 500 includes a Session Border Gateway SBG 502 and IMS operator 500′ includes a similar Session Border Gateway SBG 502′. The Session Border Gateways 502, 502′ generally act as communication gateways towards each other both for control signalling and for the session itself, and may comprise a plurality of individual gateway functions for different communication protocols and different types of media and messages. “GSM Association” is an organization for creating interconnect solutions for IMS operators in order to facilitate the establishment of such agreements, using an intermediate transit operator referred to as the IPX (IP exchange) operator, not to be confused with the transaction router “IPX” mentioned in the background section above with reference to WO 2004/086276. IMS operators then only need to establish an agreement with the intermediate transit operator.

In FIG. 5, a SIP-based signalling dialogue is initially conducted, as indicated by a dashed two-way arrow between A and C in the figure, in order to establish the actual session between client A and content provider C. After the signalling dialogue, the session itself is conducted, as indicated by a thick two-way arrow below, and may involve a purchase dialogue and/or delivery of media from the content provider.

In the signalling dialogue, various SIP messages are handled by a P-CSCF node 504 and an S-CSCF node 506 in the IMS network of operator 500 for client A. The first message in the signalling dialogue is typically an SIP INVITE message from client A, requesting a session with content provider C. In one possible implementation, the exchanged SIP messages can be likewise handled by a P-CSCF node 504′ and an S-CSCF node 506′ in the IMS network of operator 500′ for content provider C. Alternatively, instead of involving the P-CSCF node 504′, the signalling may be routed over the ISC (IP multimedia Subsystem Service Control) interface which is generally used between the S-CSCF node 506′ and any involved service platforms. The ISC interface can then lead to a so-called B2B (Business-to-Business) interface towards the content provider C.

An Application Server AS 508 connected to S-CSCF node 506 is invoked for executing the requested session for client A. Application Server 508 also provides session-related information as input to a Media Resource Function MRF 510, as indicated by an arrow from AS 508 to MRF 510. During the session, the media stream resources required for the session are controlled by the MRF 510 based on the input from application server 508, according to conventional procedures. If delivered by means of the IMS session, MRF 510 may also check and confirm that purchased media is actually being delivered properly. MRF 510 may further record or log the delivery for future retrieval, if necessary, e.g. to settle any disagreements regarding the purchase.

In the same manner, an Application Server AS 508′ connected to S-CSCF node 506′ provides session-related information on behalf of content provider C, to a corresponding Media Resource Function 510′, as indicated by an arrow from AS 508′ to MRF 510′.

In addition, application servers 508 and 508′ also provide relevant session-related information to charging functions CH 512 and CH 512′, respectively, as indicated by arrows from AS 508/508′ to CH 512/512′, in order to establish a bill at some point after the forthcoming purchase. Of course, the amount to be billed depends at least partly on the nature of the session which is specified by the input from the application servers 508/508′.

Further, a policy function 514 at IMS operator 500 applies any prevailing policy and rules to determine QoS (Quality of Service) parameters (e.g. relating to bandwidth, priorities, etc.) in the used access network (not shown here) for media components of the forthcoming session, among other things. The policy function 512 is sometimes referred to as a “Policy Control Function PCF”, and may be a separate node as shown here, or may reside within the P-CSCF node 504. In the present embodiment, the policy function 514 also provides policy data to the charging function 512 that may typically affect the billing. A corresponding policy function (not shown) at IMS operator 500′ may also be used for content provider C as well.

A database element HSS 516, 516′ at each IMS operator 500, 500′ stores subscriber and authentication data for attached IMS clients and IMS content providers. In this case, HSS 516 stores a unique identity ID_{A} assigned to client A, and HSS 516′ stores a unique identity ID_{C} assigned to content provider C. In particular, the identity ID_{A} is used by IMS operator 500 to authenticate the client A during registration. IMS operator 500 can then certify client A as trustworthy towards content provider C. Moreover, the identity ID_{C} is used for authenticating the content provider C during a registration procedure, such that content provider C and its associated aliases for products and services can be certified as trustworthy towards client A. It is possible to execute the authentication procedure by means of the nodes P-CSCF 504′ and S-CSCF 506′, based on the identity ID_{C} and other authentication data stored in HSS 516′. Otherwise, traditional business interfaces may be used for authenticating the content provider, as mentioned above.

When establishing the present communication session for a content purchase during the SIP-based signalling dialogue, IMS operator 500′ can thus verify the identity of content provider C towards client A and operator 500, allowing for safe billing by operator 500 for the content purchase. Likewise, IMS operator 500 can verify the identity of client A towards content provider C and operator 500′. Thereby, no separate trusted relationship between content provider C and operator 500, nor the above-mentioned transaction router solution, is needed to accomplish safe billing in this manner. In this case, a chain of trusted relationships is formed over content provider C, operator 500′, an optional transit operator (not shown), operator 500 and client A, such that the identities of content provider C and client A can be guaranteed reciprocally.

As indicated above, the charging functions 512 and 512′ may collect various billing-related information from application servers 508, 508′ and policy function 514 that will be used as input to the billing of client A for the purchase. In an exemplary billing procedure, content provider C may thus provide charging input regarding the content purchase to charging function 512′, as indicated by a first step 5:1, e.g. for media delivered during the session, or for content including any physical objects or services to be delivered separately, e.g. by post mail or otherwise. Charging function 512′ then basically charges the client's operator 500 for the purchase by providing relevant charging information to charging function 512 at operator 500, as indicated by a next step 5:2. In practice, this step can be incorporated in settlement of the overall balance between the two operators 500 and 500′, as a result of their interconnect agreement typically involving transactions for numerous purchases made in either direction.

Then, charging function 512 can create a bill based on the charging information from charging Function 512′ and on the input from application server 508 and policy function 514. The created bill can then be presented to client A in a suitable manner, as indicated by a step 5:3. The presented bill may be a regular subscription bill including the amount for one or more executed content purchases such as the one described.

In addition, IMS operator 500 will somehow provide payment for the purchase to the IMS operator 500′ of content provider C. As illustrated by a final step 5:4, charging function 512′ is thus financially compensated by charging function 512 for the purchase. Content provider C may then receive reimbursement for the purchase from its IMS operator 500′ in a suitable manner, which however lies outside the scope of the present invention. As in step 5:2, this can be incorporated in settlement of the overall balance between operators 500 and 500′. Alternatively, IMS operator 500 may provide reimbursement directly to content provider C, depending on the implementation. In general, the present solution does not exclude that content provider C can even send an invoice directly to client A for the purchase.

The skilled person will readily understand that the financial transactions involved in steps 5:1-5:4 above can be implemented in any suitable manner, subject to the operators' interconnect agreement and subscriptions/agreements between the operators and their attached clients and content providers, however lying outside the scope of the present invention.

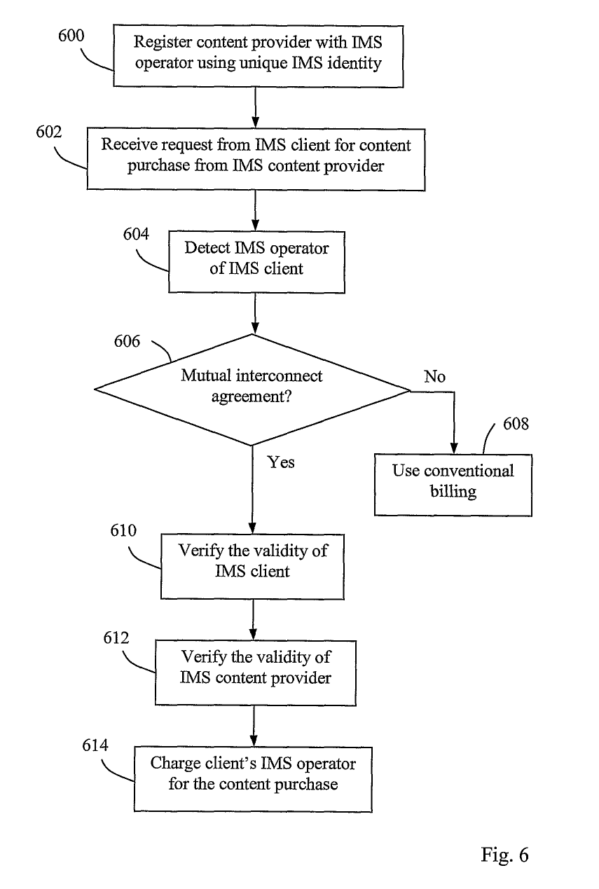

FIG. 6 is a flow chart generally illustrating a procedure for validating an IMS client and a content or service provider attached to an IMS operator, when used to provide safe billing when the IMS client purchasing content and/or services from the content provider. The shown procedure is executed at the IMS operator of the content provider, involving at least an S-CSCF node, a database element HSS and some charging function, e.g. as illustrated in FIG. 5. A corresponding procedure can also be executed at the IMS operator of the client.

In a first step 600, the content provider is initially registered with its IMS operator in a suitable authentication procedure using a unique IMS identity that has been assigned to the content provider. As mentioned above, authenticating the provider and its products/services can be made by means of traditional business interfaces such as IP-sec tunnels or the WebService Security, or by using a similar authentication mechanism as employed for IMS clients.

In a next step 602, a request for a content purchase directed to the IMS-attached content provider is received from the IMS client. A next step 604 illustrates that the IMS operator of the requesting client is detected in order to determine whether a mutual interconnect agreement exists between the two IMS operators, in a following step 606. If no such agreement exists, some conventional billing procedure must be used for charging the client for the purchase, as indicated in a step 608 falling outside the present solution. In that case, a separate parallel solution must be used if a safe purchase and billing procedure are desired, which the present invention however intends to avoid.

Thus, if it is found in step 606 that an interconnect agreement exists between the IMS operators, the validity of the IMS client can be generally verified by his/her IMS operator towards the IMS content provider and its IMS operator, in a step 610, safely relying on the operators' interconnect agreement. Further, the validity of the IMS content provider (and its products/services) can be generally verified in a similar manner based on its unique IMS identity towards the requesting client and his/her IMS operator, in a step 612. The requested purchase can then be safely executed.

Finally, after the requested content has been delivered to the client according to the purchase request, either as media in a communication session or otherwise, the client's IMS operator is charged for the content purchase in a final step 614. Reference is made here to the above-described steps 5:1-5:4 in FIG. 5.

The present invention makes it possible to safely verify the validity of a client towards a content provider, and vice versa, in order to enable secure and reliable purchasing of content or services therefrom as well as billing for the content. In the same way as for clients, also a content or service provider can be given one unique IMS identity by which the provider is recognised by the IMS operator. One or more public aliases associated with the unique IMS identity can also be used, e.g. similar to the concept of IMPI/IMPU used for clients today. According to the present solution, such aliases can be used for identifying any content, i.e. products and/or services, offered by the content provider. Any associated aliases both for the client and the content provider can thus be verified by their respective IMS operators. Since an alias for a client can be verified by the IMS operator, it can basically replace the conventional user identity/password used today.

If a plurality of IMS operators have settled mutual interconnect agreements, the identity of a content provider or client can be guaranteed across any of these IMS operators. An interconnect agreement may be formed based on the so-called “originator pays paradigm”, implying that the originating client's IMS operator collects all costs for the entire activity including costs for used resources at all involved parties, even the terminating IMS operator.

In this invention, the content or service provider has a trusted relationship with one IMS operator based on one basic unique identity and optionally a set of aliases administrated by the IMS operator. Furthermore, an added capability is that a content provider may have access to the charging system of the IMS operator, such that the content provider can define service and content costs that will be treated in the same manner as any costs for used communication resources. In other words, any costs for delivery of content and services can be uniformly billed together with regular subscriber costs, e.g. using the interconnect agreements.

The identity of an originating client can be transferred to a contacted content or service provider at the time of connect, basically in the same manner as to any contacted terminating client at the time of connect. Thereby, it is possible for the content provider to tailor the response according to the profile and history of the originating client, if known.

The present invention can be used for the purchase of any type of content or services, equalling what can be experienced on the Internet today. When conducting a session between a client and a content provider for a content purchase, involving a purchase dialogue and optionally the content delivery, the acceptance for payment for the purchase can also be secured as part of the session.

The present invention can further be used to secure payment for a content purchase in the following way. Payment requirements can be sent from the selling content provider to the IMS operator taking responsibility for the provider's identity. These requirements are then further conveyed to the IMS operator from which the purchase request came, which may be a transit operator, and so forth, in an arbitrary number of steps. Finally, it reaches the IMS operator to which the requesting client belongs, and the payment is collected from the buying client, e.g. by means of his/her regular subscription bill, which is conveyed back to the content provider the same way.

While the invention has been described with reference to specific exemplary embodiments, the description is generally only intended to illustrate the inventive concept and should not be taken as limiting the scope of the invention, which is defined by the appended claims.

1. A method of providing security when an IMS client purchases content from a content or service provider, the IMS client having a unique IMS identity registered with a first IMS operator, comprising the following steps:
assigning a unique IMS identity to said content or service provider by a second IMS operator,
authenticating the content or service provider based on its assigned IMS identity, and
verifying the validity of the IMS client towards the content or service provider in response to a purchase request from the IMS client, said first and second IMS operators having settled a mutual interconnect agreement.

2. A method according to claim 1, wherein at least one alias associated with the IMS client's IMS identity is verified towards the content or service provider.

3. A method according to claim 1, wherein the validity of the content or service provider is verified towards the IMS client.

4. A method according to claim 3, wherein at least one alias associated with the content or service provider's IMS identity is verified towards the IMS client, each alias representing an offered product or service.

5. A method according to claim 1, wherein an IMS communication session is conducted between the IMS client and the content or service provider, involving a purchase dialogue and/or delivery of media from the content or service provider.

6. A method according to claim 5, wherein the second IMS operator charges the first IMS operator for the client's content purchase and then provides reimbursement for the purchase to the content or service provider.

7. A method according to claim 6, wherein the first IMS operator is charged based on session-related input from an application server invoked for the communication session.

8. A method according to claim 5, wherein a charging function of the second IMS operator receives charging input from the content or service provider regarding the content purchase for media delivered during the session, and/or for content delivered separately.

9. A method according to claim 8, wherein the charging function of the second IMS operator provides relevant charging information to a charging function of the first IMS operator, in order to charge the first IMS operator for the client's purchase.

10. A method according to claim 9, wherein the charging function of the first IMS operator creates a bill to the client for the purchase, based on said charging information from the charging function of the second IMS operator.

11. A method according to claim 10, wherein the charging function of the second IMS operator is financially compensated by the charging function of the first IMS operator for the purchase.

12. An arrangement for providing security when an IMS client purchases content from a content or service provider, the IMS client having a unique IMS identity registered with a first IMS operator, comprising:
means for assigning a unique IMS identity to said content or service provider by a second IMS operator,
means for authenticating the content or service provider based on the assigned IMS identity, and
means for verifying the validity of the IMS client towards the content or service provider in response to a purchase request from the IMS client, said first and second IMS operators having settled a mutual interconnect agreement.

13. An arrangement according to claim 12, wherein said means for verifying the validity of the IMS client is adapted to verify at least one alias associated with the IMS client's IMS identity towards the content or service provider.

14. An arrangement according to claim 12, further comprising means for verifying the validity of the content or service provider towards the IMS client.

15. An arrangement according to claim 14, wherein said means for verifying the validity of the content or service provider is adapted to verify at least one alias associated with the content or service provider's IMS identity towards the IMS client, each alias representing an offered product or service.

16. An arrangement according to claim 12, wherein an IMS communication session is conducted between the IMS client and the content or service provider, involving a purchase dialogue and/or delivery of media from the content or service provider.

17. An arrangement according to claim 16, wherein the second IMS operator comprises means for charging the first IMS operator for the client's content purchase, and for providing reimbursement for the purchase to the content or service provider.

18. An arrangement according to claim 17, wherein said means for charging the first IMS operator is adapted to charge the first IMS operator based on session-related input from an application server invoked for the communication session.

19. An arrangement according to claim 16, wherein a charging function of the second IMS operator is adapted to receive charging input from the content or service provider regarding the content purchase for media delivered during the session, and/or for content delivered separately.

20. An arrangement according to claim 19, wherein the charging function of the second IMS operator is further adapted to provide relevant charging information to a charging function of the first IMS operator, in order to charge the first IMS operator for the client's purchase.

21. An arrangement according to claim 20, wherein the charging function of the first IMS operator is adapted to create a bill to the client for the purchase, based on said charging information from the charging function of the second IMS operator.

22. An arrangement according to claim 21, wherein the charging function of the second IMS operator is further adapted to be financially compensated by the charging function of the first IMS operator for the purchase.
